(19) United States
(12) Patent Application Publication
(10) Pub. No.: US 2024/0134503 A1
(43) Pub. Date: Apr. 25, 2024

(54) CONTROL METHOD AND APPARATUS FOR DISPLAYING MULTIMEDIA CONTENT, ELECTRONIC DEVICE AND MEDIUM

(71) Applicant: BEIJING YOUZHUJU NETWORK TECHNOLOGY CO. LTD., Beijing (CN)

(72) Inventors: Keke HUANG, Beijing (CN); Xue YAO, Beijing (CN); Xiaolei SHI, Beijing (CN); Mengqi WU, Beijing (CN); Weiqin LIAN, Beijing (CN); Junhao ZHANG, Beijing (CN); Zhiquan ZHANG, Beijing (CN); Bo ZHOU, Beijing (CN); Zhiyong LUO, Beijing (CN); Ji LI, Beijing (CN)

(21) Appl. No.: 18/546,445

(22) PCT Filed: Feb. 25, 2022
(86) PCT No.: PCT/CN2022/077789

§ 371 Date: Aug. 14, 2023

(30) Foreign Application Priority Data
Feb. 25, 2021 (CN) 202110214882.1

(51) Int. Cl. G06F 3/0484; G06F 3/0481; G06F 3/04883

(52) U.S. Cl. CPC G06F 3/0484; G06F 3/0481; G06F 3/04883

(57) ABSTRACT

A control method and apparatus for displaying multimedia content, an electronic device, and a medium. The method includes: displaying a first-type multimedia content on a first content display layer of a first-type multimedia content display interface, the first-type multimedia content display interface including: a first user interaction layer and the first content display layer, the first user interaction layer being superimposed and displayed on the first content display layer; and receiving a first swiping operation inputted by a user on the user interaction layer, and exiting the first-type multimedia content display interface. That is, a swiping operation triggers to exit the first-type multimedia content display interface, as the swiping operation is significantly different from a click operation, the user is provided with a multimedia content display control method that is more consistent with the user's operation habit, improving the user experience.

This application is a national stage of International Application No. PCT/CN2022/077789, filed on Feb. 25, 2022, which claims the priority to Chinese Patent Application No. 202110214882.1, titled “CONTROL METHOD AND APPARATUS FOR DISPLAYING MULTIMEDIA CONTENT, ELECTRONIC DEVICE AND MEDIUM”, filed on Feb. 25, 2021 with the Chinese Patent Office, both of which are incorporated herein by reference in their entireties.

### FIELD

The present disclosure relates to the field of multimedia technology, and in particular to a method and an apparatus for controlling display of multimedia content, an electronic device, and a medium.

### BACKGROUND

With the rapid development of internet technology, more and more types of applications are developed. Displaying specific multimedia content in applications has become a common way of delivering multimedia content. For example, specific multimedia content may be displayed on a buffering interface of an application, on a startup interface of the application, or on an exit interface of the application. The specific multimedia content may include advertisements or promotional content, etc.

In some applications, users can skip the display of specific multimedia content by using a skip button displayed on a display interface of the specific multimedia content. For example, in existing technology, the application generally displays an open screen advertisement after being started, and displays a “skip advertisement” button in the upper left, lower left, lower right, or upper right corner of the display interface of the open screen advertisement. If the user clicks this button on the display interface of the open screen advertisement, the display of the advertisement will be skipped and another interface of the application will be displayed. If the user clicks on an area other than the button on the display interface of the open screen advertisement, the advertisement will be entered, such as displaying information related to the advertisement. If the user does not perform any operation, another interface of the application will be automatically displayed after the display of the open screen advertisement is completed.

However, the existing technology often results in a poor user experience.

### SUMMARY

In order to solve or at least partially solve the above technical problem, a method and an apparatus for controlling display of multimedia content, an electronic device, and a medium are provided in the present disclosure.

In a first aspect, a method for controlling display of multimedia content is provided, including:
displaying first type multimedia content on a first content display layer of a first type multimedia content display interface, where the first type multimedia content display interface includes a first user interaction layer and the first content display layer, and the first user interaction layer is superimposed and displayed on the first content display layer; and
receiving a first sliding operation inputted by a user on the first user interaction layer, and exiting the first type multimedia content display interface.

In a possible embodiment, before the receiving the first sliding operation inputted by the user on the first user interaction layer, the method further includes:
displaying exit prompt information on the first user interaction layer, where the exit prompt information is used to prompt to exit the first type multimedia content display interface through the first sliding operation.

In a possible embodiment, the exit prompt information includes text prompt information and/or graphic prompt information, where the graphic prompt information includes a sliding direction icon used to indicate a sliding direction of the first sliding operation.

In a possible embodiment, the exit prompt information is displayed on the first user interaction layer with a dynamic effect.

In a possible embodiment, the exit prompt information is displayed on the first user interaction layer at a time delayed from a start display time of the first type multimedia content by a preset time.

In a possible embodiment, the first type multimedia content includes open screen information.

In a possible embodiment, the method further includes:
sending a request to a server, where the request is used for requesting second type multimedia content from the server;
where after the exiting the first type multimedia content display interface, the method further includes:
displaying the second type multimedia content acquired from the server on a second content display layer of a second type multimedia content display interface, where the second type multimedia content display interface includes a second user interaction layer and the second content display layer, and the second user interaction layer is superimposed and displayed on the second content display layer.

In a possible embodiment, after the exiting the first type multimedia content display interface, and before the displaying the second type multimedia content acquired from the server on the second content display layer of the second type multimedia content display interface, the method further includes:
displaying at least one second type multimedia content which is locally pre-cached, on the second content display layer of the second type multimedia content display interface.

In a possible embodiment, after the displaying the at least one second type multimedia content which is locally pre-cached, on the second content display layer of the second type multimedia content display interface, the method further includes:

receiving a second sliding operation inputted by the user on the second user

interaction layer of the second type multimedia content display interface; and

displaying the first type multimedia content on the second content display layer of the second type multimedia content display interface.

In a possible embodiment, the method further includes:
receiving a click operation inputted by the user on the first user interaction layer, and entering an information interface related to the first type multimedia content.

In a second aspect, an apparatus for controlling display of multimedia content is provided, including:
a display module, configured to display first type multimedia content on a first content display layer of a first type multimedia content display interface, where the first type multimedia content display interface includes a first user interaction layer and the first content display layer, and the first user interaction layer is superimposed and displayed on the first content display layer;
a receiving module, configured to receive a first sliding operation inputted by a user on the user interaction layer; and
a processing module, configured to exit the first type multimedia content display interface in response to the first sliding operation inputted by the user on the user interaction layer.

In a possible embodiment, the display module is further configured to display exit prompt information on the first user interaction layer, where the exit prompt information is used to prompt to exit the first type multimedia content display interface through the first sliding operation.

In a possible embodiment, the exit prompt information includes text prompt information and/or graphic prompt information, where the graphic prompt information includes a sliding direction icon used to indicate a sliding direction of the first sliding operation.

In a possible embodiment, the exit prompt information is displayed on the first user interaction layer with a dynamic effect.

In a possible embodiment, the exit prompt information is displayed on the first user interaction layer at a time delayed from a start display time of the first type multimedia content by a preset time.

In a possible embodiment, the first type multimedia content includes open screen information.

In a possible embodiment, the apparatus further includes:
a sending module, configured to send a request to a server, where the request is used for requesting second type multimedia content from the server; and
the display module is further configured to display the second type multimedia content acquired from the server on a second content display layer of a second type multimedia content display interface, where the second type multimedia content display interface includes a second user interaction layer and the second content display layer, and the second user interaction layer is superimposed and displayed on the second content display layer.

In a possible embodiment, the display module is further configured to display at least one second type multimedia content which is locally pre-cached, on the second content display layer of the second type multimedia content display interface.

In a possible embodiment, the receiving module is further configured to receive a second sliding operation inputted by the user on the second user interaction layer of the second type multimedia content display interface; and

the display module is further configured to display the first type multimedia content on the second content display layer of the second type multimedia content display interface.

In a possible embodiment, the receiving module is further configured to receive a click operation inputted by the user on the first user interaction layer, and enter an information interface related to the first type multimedia content.

In a third aspect, an electronic device is also provided, including a processor configured to execute a computer program stored in a memory, where the computer program, when being executed by the processor, implements steps of the method described in the first aspect.

In a fourth aspect, a computer-readable storage medium is also provided, on which a computer program is stored, where the computer program, when being executed by a processor, implements steps of the method described in any item of the first aspect.

In a fifth aspect, a computer program product is also provided, where the computer program product, when running on a computer, causes the computer to execute steps of the method described in any item of the first aspect.

Compared with the existing technology, the technical solutions of the embodiments in the present disclosure have at least the following advantages.

The first type multimedia content is displayed on the first content display layer of the first type multimedia content display interface, where the first type multimedia content display interface includes the first user interaction layer and the first content display layer. The first user interaction layer is superimposed and displayed on the first content display layer. The first sliding operation inputted by the user on the first user interaction layer is received, and the first type multimedia content display interface is exited. Therefore, the exiting of the first type multimedia content display interface is triggered through the sliding operation. Due to the significant difference between the sliding operation and the clicking operation, the user experience is improved by providing users with a method for controlling display of multimedia content that is more in compliance with operating habits of users.

### BRIEF DESCRIPTION OF THE DRAWINGS

The drawings herein are incorporated into the specification and constitute a part of the specification, which show embodiments of the present disclosure. The drawings and the specification are used to explain the principle of the present disclosure together.

In order to more clearly explain the embodiments of the present disclosure or the technical solutions in the conventional art, the drawings used in the description of the embodiments or the conventional art are briefly introduced below. Apparently, for those skilled in the art, other drawings may be obtained according to the provided drawings without any creative effort.

FIG. 1 is a flowchart of a method for controlling display of multimedia content provided in the present disclosure;

FIG. 2 is a schematic diagram of a display interface for displaying multimedia content provided in the present disclosure;

FIG. 3 is a schematic diagram of another display interface for displaying multimedia content provided in the present disclosure;

FIG. 4 is a flowchart of another method for controlling display of multimedia content provided in the present disclosure;

FIG. 5 is a schematic diagram of yet another display interface for displaying multimedia content provided in the present disclosure;

FIG. 6 is a schematic diagram of further another display interface for displaying multimedia content provided in the present disclosure;

FIG. 7 is a schematic diagram of still further another display interface for displaying multimedia content provided in the present disclosure;

FIG. 8 is a flowchart of yet another method for controlling display of multimedia content provided in the present disclosure;

FIG. 9 is a flowchart of still another method for controlling display of multimedia content provided in the present disclosure; and

FIG. 10 is a schematic structural diagram of an apparatus for controlling display of multimedia content provided in the present disclosure.

### DETAILED DESCRIPTION OF EMBODIMENTS

In order to make the above purposes, features and advantages of the present disclosure clearer to understand, the technical solutions in the embodiments of the present disclosure will be described in detail hereinafter. It should be noted that the embodiments of the present disclosure and the features in the embodiments may be combined with each other in case of no occurrence of conflicts.

Although many specific details are set forth in the following description to facilitate a full understanding of the present disclosure, the present disclosure may also be implemented in other ways than those described herein. Apparently, the embodiments in the specification are only some of embodiments of the present disclosure, not all of them.

The technical solutions of the present disclosure may be applied to terminals having a touch screen. The terminals may include computers, tablets, mobile phones, wearable electronic devices, smart home devices or other terminals. The terminals are installed with applications (Apps), which may include various types of applications.

The application may display not only multimedia content related to the application itself, but also display some other multimedia content. For the convenience of description, such other multimedia content is described as first type multimedia content in the present disclosure. The first type multimedia content may be open screen information, which may include a brand slogan of the application, an open screen advertisement, a notification or promotional information. When the application displays the first type multimedia content, the first type multimedia content display interface may include two layers, one of which is a content display layer used to display the first type multimedia content, and the other of which is a user interaction layer used to receive operation instructions inputted by a user. The user interaction layer is superimposed and displayed on the content display layer. The user interaction layer is usually in a transparent or semi-transparent state to facilitate users in viewing the multimedia content.

The user interaction layer of the first type multimedia content display interface in the present disclosure can receive at least two types of user operations, one of which is a click operation, and the other of which is a sliding operation. When the user inputs a click operation on the user interaction layer, a detail page of the first type multimedia content can be entered. When the user inputs a sliding operation on the user interaction layer, the first type multimedia content display interface can be exited.

Due to the significant difference between the sliding operation and the clicking operation, the user experience is improved by providing users with the method for controlling display of multimedia content that is more in compliance with operating habits of users.

Below, several embodiments are used as examples to describe the technical solutions of the present disclosure.

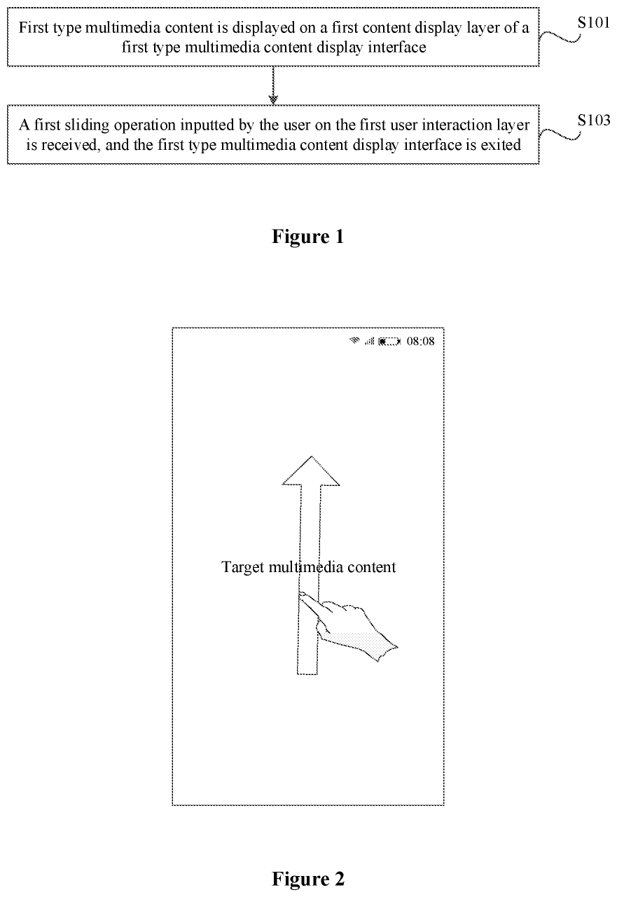

FIG. 1 is a flowchart of a method for controlling display of multimedia content provided in the present disclosure. This embodiment is executed by a terminal. As shown in FIG. 1, the method of this embodiment includes steps S101 and S103.

In step S101, first type multimedia content is displayed on a first content display layer of a first type multimedia content display interface.

The first type multimedia content may be open screen information, which may include a brand slogan of the application, an advertisement, a notification, or promotional information. Taking the advertisement as an example, the first type multimedia content may be an open screen advertisement (also known as an above-the-fold advertisement or a splash screen advertisement), that is, the multimedia content displayed on the display interface firstly displayed to the user after the application is started.

The first type multimedia content display interface includes a first user interaction layer and a first content display layer. The first user interaction layer is superimposed and displayed on the first content display layer. The first content display layer is used to display the first type multimedia content, and the first user interaction layer is used to receive operation instructions inputted by the user. The first user interaction layer is in a transparent or semi-transparent state.

In a possible embodiment, the operation instructions inputted by the user include but are not limited to clicking and sliding. If the user inputs a click operation on the first user interaction layer, the detail page of the first type multimedia content is entered. If the user inputs a sliding operation on the first user interaction layer, the first type multimedia content display interface is exited. For example, if the user is interested in an open screen advertisement and wants to further know the detailed content of the advertisement, the user can input a click operation on the first user interaction layer, so that the detailed content page of the advertisement is jumped to. If the user wants to view other multimedia content of the application, the user can input a sliding operation on the first user interaction layer, so that the current open screen advertisement is exited and the user can view other multimedia content of the application.

In step S103, a first sliding operation inputted by the user on the first user interaction layer is received, and the first type multimedia content display interface is exited.

In a possible embodiment, the first sliding operation may include a sliding operation that meets a preset condition. For example, the preset condition may be set based on a starting position of sliding, a sliding direction, a sliding trajectory, a sliding time and/or a sliding distance. The starting position of sliding may include, for example, an operating area that can avoid an exit screen of full screen. The sliding direction for example may be upward, downward, leftward, rightward, or a direction having a preset angle with a perpendicular bisector of the screen. The sliding trajectory may be a straight line, a polyline, or a curve. The sliding time and sliding distance may be set according to scenes; for example, reasonable values may be set based on the size of the display screen of the terminal device.

For example, if the preset condition is that the sliding direction is upward, then as long as the user inputs a sliding up operation on the user interaction layer, the first type multimedia content display interface will be exited from display. For another example, if the preset condition is that the sliding direction is upward or downward, then as long as the user inputs a sliding up or sliding down operation on the user interaction layer, the first type multimedia content display interface will be exited from display.

In a possible embodiment, the first sliding operation may be user-customized. A setting interface may be provided for users to set the first sliding operation that meets their personalized needs to exit the first type multimedia content display interface, thereby improving the flexibility of the first sliding operation. In this way, the user experience is further improved by providing the method for controlling display of multimedia content that is more in compliance with operating habits of users.

The exiting the first type multimedia content display interface from display includes but is not limited to the following possible ways.

In a possible way, when the user inputs the first sliding operation on the first user interaction interface, the first type multimedia content display interface moves with the sliding of the user finger until the user finger leaves the screen, at which time the first type multimedia content display interface is exited.

In another possible way, when the user inputs the first sliding operation on the first user interaction interface, the first type multimedia content display interface moves with the sliding of the user finger. When the first type multimedia content display interface is smaller than a preset area of the screen (such as an area of ½ of the screen), the first type multimedia content display interface is exited after the user finger leaves the screen. When the first type multimedia content display interface is larger than or equal to the preset area of the screen, the display of the first type multimedia content display interface is restored after the user finger leaves the screen.

In further another possible way, when the user inputs a sliding operation on the first user interaction interface, the first type multimedia content display interface does not move with the sliding of the finger. When the sliding operation meets the preset condition, the first type multimedia content display interface is directly exited.

In this embodiment, the first type multimedia content is displayed on the first content display layer of the first type multimedia content display interface, where the first type multimedia content display interface includes the first user interaction layer and the first content display layer. The first user interaction layer is superimposed and displayed on the first content display layer. The first sliding operation inputted by the user on the user interaction layer is received, and the first type multimedia content display interface is exited. Therefore, the exiting of the first type multimedia content display interface is triggered through the sliding operation. Due to the significant difference between the sliding operation and the clicking operation, the user experience is improved by providing users with a method for controlling display of multimedia content that is more in compliance with operating habits of users.

In the embodiment shown in FIG. 1, the first user interaction layer of the first type multimedia content display interface may display exit prompt information, or optionally may not display the exit prompt information.

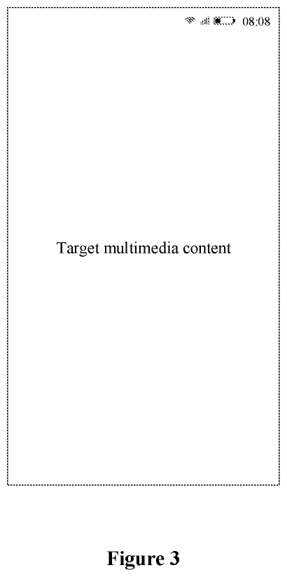

For example, when the user operates the application for the first time or for the first N times, the exit prompt information may be displayed, where N is an integer larger than or equal to 2. For example, the exit prompt information is: sliding up to exit the display interface, as shown in FIG. 2, which displays a sliding up arrow and a gesture. In a possible embodiment, the sliding up arrow and gesture may be displayed with a dynamic effect. When the user operates the application again, the exit prompt information is no longer displayed, as shown in FIG. 3. The user can, according to the previous operating experience, slide up to exit the first type multimedia content display interface. By displaying the exit prompt information for the first operation and not displaying it subsequently, the interface can be more concise, further improving the user experience.

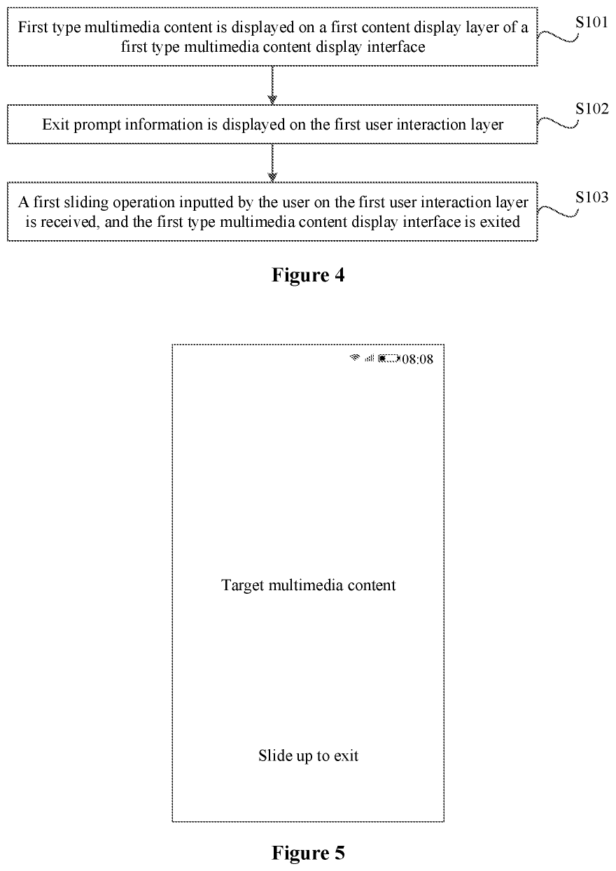

The exit prompt information may be displayed on the first user interaction layer of the first type multimedia content display interface to prompt to exit the first type multimedia content display interface through the first sliding operation. As shown in FIG. 4, based on the embodiment shown in FIG. 1, the method further includes step S102 before S103.

In step S102, exit prompt information is displayed on the first user interaction layer.

In a possible embodiment, the exit prompt information may include: text prompt information and/or graphic prompt information. The graphic prompt information includes a sliding direction icon, which is used to indicate the sliding direction of the first sliding operation.

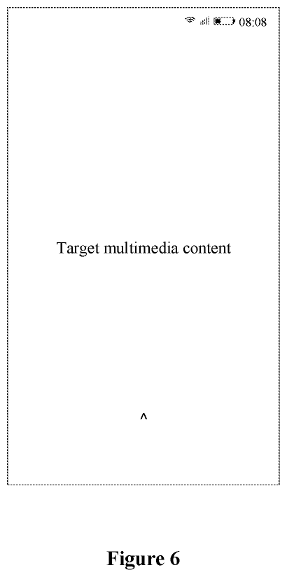

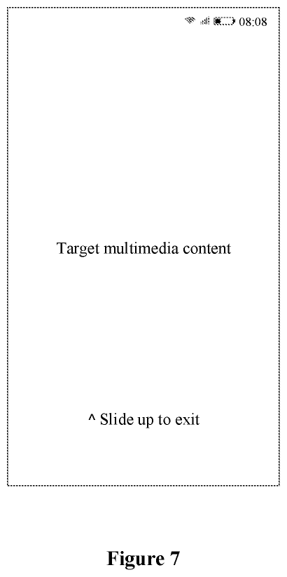

As shown in FIG. 5, the exit prompt information shown in FIG. 5 is text prompt information, the specific content of which may be “slide up to exit”. As shown in FIG. 6, the exit prompt information shown in FIG. 6 is graphic prompt information, the specific content of which may include “A”. This sliding direction icon is used to indicate sliding up. As shown in FIG. 7, the exit prompt information shown in FIG. 7 includes both text prompt information and graphic prompt information, the specific content of which is “A slide up to exit”. It should be understood by those skilled in the art that the various types of prompt information mentioned above are only exemplary, and in practice, different exit prompt information can be displayed according to the actual application needs.

In a possible embodiment, the exit prompt information may be displayed on the user interaction layer with a dynamic effect (such as a micro-dynamic effect), thereby achieving the effect of prompting the user.

In a possible embodiment, the exit prompt information may be displayed on the first user interaction layer from the very beginning, or may be displayed on the first user interaction layer at a time delayed from the start display time of the first type multimedia content by a preset time. For example, the exit prompt information may be displayed with a delay of 1 second, which means that the first user interaction layer does not display any content at the beginning, and after 1 second, the first user interaction layer displays the exit prompt information.

In a possible embodiment, the color of the exit prompt information, such as font color and/or icon color, may be adjusted according to the color of the first type multimedia content, so as to facilitate the highlighting of the exit prompt information.

In a possible embodiment, the exit prompt information may be displayed on a shading bar, so as to facilitate the highlighting of the exit prompt information.

In this embodiment, by displaying the exit prompt information on the first user interaction layer, the user can be more intuitively informed of the way to exit the first type multimedia content display interface, which can further improve the user experience.

In the above embodiments, after the first type multimedia content display interface is exited, the content related to the application itself is displayed.

In the above embodiments, the method may further include: receiving a click operation inputted by the user on the first user interaction layer, and entering an information interface related to the first type multimedia content.

For example, when the first type multimedia content is an open screen advertisement, the user may input a click operation on the first user interaction layer so that the detail page of the advertisement can be entered.

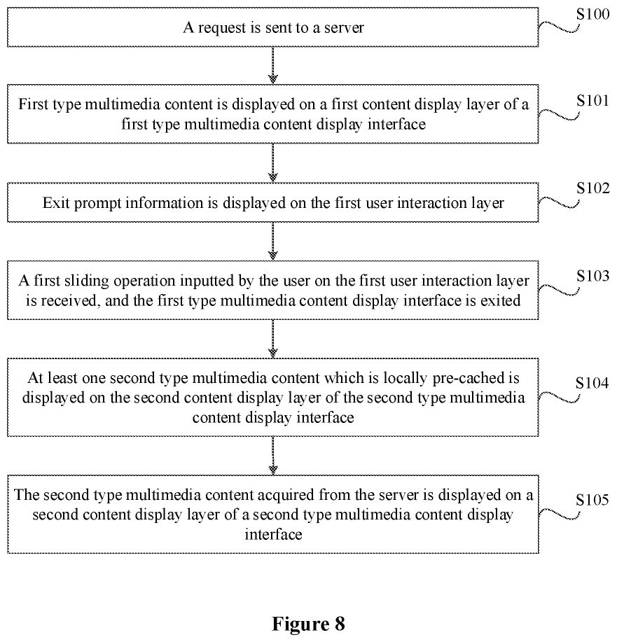

FIG. 8 is a flowchart of yet another method for controlling display of multimedia content provided in the present disclosure. Based on the above embodiments, FIG. 8 further includes step S100.

In step S100, a request is sent to a server.

The request is used to request second type multimedia content from the server.

In a possible embodiment, this step may be executed before or after the above step of “displaying the first type multimedia content on the first content display layer of the first type multimedia content display interface”. For example, the request may be sent to the server once the application is started, or during displaying the first type multimedia content, or after exiting the display interface of the first type multimedia content, which is not limited herein.

After S102, the method may further include step S105.

In step S105, the second type multimedia content acquired from the server is displayed on a second content display layer of a second type multimedia content display interface.

The second type multimedia content display interface includes a second user interaction layer and the second content display layer, where the second user interaction layer is superimposed and displayed on the second content display layer.

In a possible case, if the second type multimedia content is already acquired from the server when the first type multimedia content display interface is exited, then the second type multimedia content acquired from the server is directly displayed on the second content display layer of the second type multimedia content display interface.

In another possible case, if the second type multimedia content is not yet acquired from the server when the first type multimedia content display interface is exited, then a blank page or a default page is displayed until the second type multimedia content is acquired from the server, and then the second type multimedia content acquired from the server is displayed on the second content display layer of the second type multimedia content display interface.

In a possible embodiment, in order to improve the user experience, at least one second type multimedia content is pre-cached locally in the present disclosure. Therefore, after exiting the first type multimedia content display interface, the method may include step S104 before step S105.

In step S104, at least one second type multimedia content which is locally pre-cached is displayed on the second content display layer of the second type multimedia content display interface.

In a possible embodiment, at least one second type multimedia content which is locally pre-cached is displayed on the second content display layer of the second type multimedia content display interface. Moreover, through a user operation (such as sliding up), all or part of the locally pre-cached second type multimedia content may be sequentially displayed on the second content display layer of the second type multimedia content display interface after exiting the first type multimedia content display interface.

In a possible embodiment, how much locally pre-cached second type multimedia content to be specifically displayed in response to the sliding up operation of the user is determined based on the network status. For example, if the network status of the terminal is poor, more pre-cached second type multimedia content may be displayed. If the network status of the terminal is good, less pre-cached second type multimedia content may be displayed.

In a possible embodiment, the second type multimedia content may be cached during the last-time use of the application by the user.

The at least one second type multimedia content which is locally pre-cached is displayed on the second content display layer of the second type multimedia content display interface before the second type multimedia content acquired from the server is displayed on the second content display layer of the second type multimedia content display interface, thereby avoiding the waiting time of the user and improving the user experience.

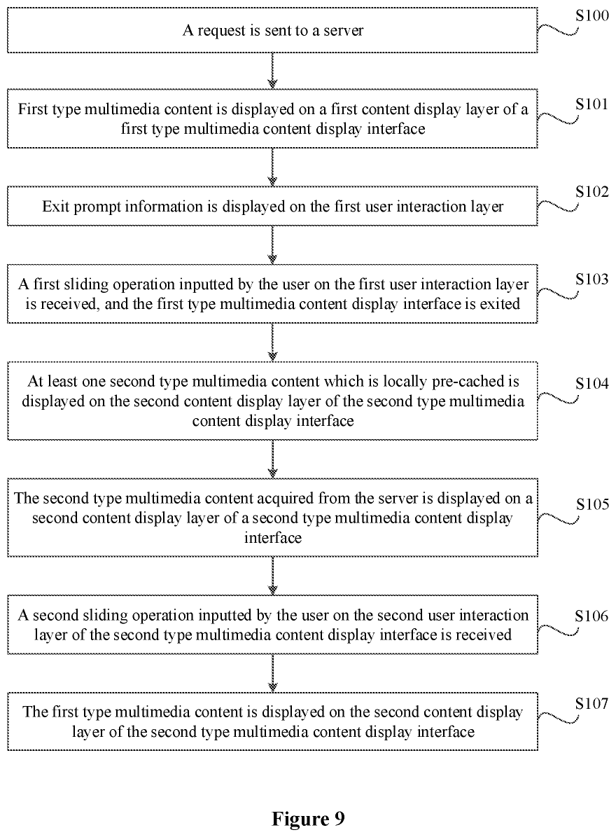

FIG. 9 is a flowchart of still another method for controlling display of multimedia content provided in the present disclosure. Based on the above embodiment shown in FIG. 8, the method shown in FIG. 9 further includes steps S106 and S107.

In step S106, a second sliding operation inputted by the user on the second user interaction layer of the second type multimedia content display interface is received.

The first sliding operation and the second sliding operation may be sliding operations in opposite directions. For example, the first sliding operation is a sliding up operation, and the second sliding operation is a sliding down operation. That is, the first type multimedia content display interface may be exited through the first sliding operation, and the first type multimedia content may be displayed through the second sliding operation.

In step S107, the first type multimedia content is displayed on the second content display layer of the second type multimedia content display interface.

In this embodiment, by receiving the second sliding operation inputted by the user on the second user interaction layer of the second type multimedia content display interface and displaying the first type multimedia content on the second content display layer of the second type multimedia content display interface, the user can repeatedly view the first type multimedia content, further improving the user experience, and also further improving the frequency of displaying the first type multimedia content.

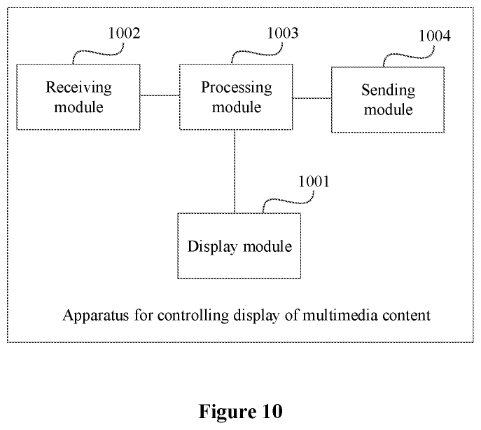

FIG. 10 is a schematic structural diagram of an apparatus for controlling display of multimedia content provided in the present disclosure. As shown in FIG. 10, the apparatus includes a display module 1001, a receiving module 1002, a processing module 1003, and a sending module 1004.

The display module 1001 is configured to display first type multimedia content on a first content display layer of a first type multimedia content display interface, where the first type multimedia content display interface includes a first user interaction layer and the first content display layer, and the first user interaction layer is superimposed and displayed on the first content display layer.

The receiving module 1002 is configured to receive a first sliding operation inputted by a user on the user interaction layer.

The processing module 1003 is configured to exit the first type multimedia content display interface in response to the first sliding operation inputted by the user on the user interaction layer.

In a possible embodiment, the display module 1001 is further configured to display exit prompt information on the first user interaction layer, where the exit prompt information is used to prompt to exit the first type multimedia content display interface through the first sliding operation.

In a possible embodiment, the exit prompt information includes text prompt information and/or graphic prompt information, where the graphic prompt information includes a sliding direction icon used to indicate a sliding direction of the first sliding operation.

In a possible embodiment, the exit prompt information is displayed on the first user interaction layer with a dynamic effect.

In a possible embodiment, the exit prompt information is displayed on the first user interaction layer at a time delayed from a start display time of the first type multimedia content by a preset time.

In a possible embodiment, the first type multimedia content includes open screen information.

In a possible embodiment, the sending module 1004 is configured to send a request to a server, where the request is used for requesting second type multimedia content from the server; and

the display module 1001 is further configured to display the second type multimedia content acquired from the server on a second content display layer of a second type multimedia content display interface, where the second type multimedia content display interface includes a second user interaction layer and the second content display layer, and the second user interaction layer is superimposed and displayed on the second content display layer.

In a possible embodiment, the display module 1001 is further configured to display at least one second type multimedia content which is locally pre-cached, on the second content display layer of the second type multimedia content display interface.

In a possible embodiment, the receiving module 1002 is further configured to receive a second sliding operation inputted by the user on the second user interaction layer of the second type multimedia content display interface.

The display module 1001 is further configured to display the first type multimedia content on the second content display layer of the second type multimedia content display interface.

In a possible embodiment, the receiving module 1002 is further configured to receive a click operation inputted by the user on the first user interaction layer, and enter an information interface related to the first type multimedia content.

The apparatus of this embodiment can be correspondingly used to execute the technical solutions of the above method embodiments, and has similar implementation principles and technical effects, which will not be described repeatedly herein.

The present disclosure also provides an electronic device, including a processor configured to execute a computer program stored in memory, where the computer program, when being executed by the processor, implements steps of the method described in any of the above method embodiments.

The present disclosure also provides a computer readable storage medium on which a computer program is stored, where the computer program, when being executed by a processor, implements steps of the method described in any of the above method embodiments.

The present disclosure also provides a computer program product, where the computer program product, when running on a computer, causes the computer to execute steps of the method described in any of the above method embodiments.

It should be noted that the relationship terms “first”, “second” and the like herein are only used for distinguishing one entity or operation from another entity or operation, not necessarily requiring or implying existence of any such actual relationship or order between these entities or operations. Furthermore, terms “include”, “comprise” or any other variants thereof are intended to cover the non-exclusive inclusion. Therefore, a process, method, article or device including a series of elements not only include these elements, but also include other elements not expressly listed or elements inherent to the process, method, article or device. Without further restrictions, an element defined by “comprising/including a(n) . . . ” does not exclude existence of another identical element in a process, method, article or device including said element.

Described above are only specific embodiments of the present disclosure, which enable those skilled in the art to understand or implement the present disclosure. Many modifications to these embodiments are obvious to those skilled in the art. The general principle defined herein may be applied to other embodiments without departing from the spirit or scope of the present disclosure. Therefore, the present disclosure will not be limited to the embodiments described herein, but shall conform to the broadest scope consistent with the principles and novel features disclosed herein.

1. A method for controlling display of multimedia content, comprising: displaying first type multimedia content on a first content display layer of a first type multimedia content display interface, wherein the first type multimedia content display interface comprises a first user interaction layer and the first content display layer, and the first user interaction layer is superimposed and displayed on the first content display layer; and
receiving a first sliding operation inputted by a user on the first user interaction layer, and exiting the first type multimedia content display interface.

2. The method according to claim 1, wherein before the receiving the first sliding operation inputted by the user on the first user interaction layer, the method further comprises:
displaying exit prompt information on the first user interaction layer, wherein the exit prompt information is used to prompt to exit the first type multimedia content display interface through the first sliding operation.

3. The method according to claim 2, wherein the exit prompt information comprises text prompt information and/or graphic prompt information, and wherein the graphic prompt information comprises a sliding direction icon used to indicate a sliding direction of the first sliding operation.

4. The method according to claim 2, wherein the exit prompt information is displayed on the first user interaction layer with a dynamic effect.

5. The method according to claim 2, wherein the exit prompt information is displayed on the first user interaction layer at a time delayed from a start display time of the first type multimedia content by a preset time.

6. The method according to claim 1, wherein the first type multimedia content comprises open screen information.

7. The method according to claim 1, further comprising:
sending a request to a server, wherein the request is used for requesting second type multimedia content from the server,
wherein after the exiting the first type multimedia content display interface, the method further comprises:
displaying the second type multimedia content acquired from the server on a second content display layer of a second type multimedia content display interface, wherein the second type multimedia content display interface comprises a second user interaction layer and the second content display layer, and the second user interaction layer is superimposed and displayed on the second content display layer.

8. The method according to claim 7, wherein after the exiting the first type multimedia content display interface, and before the displaying the second type multimedia content acquired from the server on the second content display layer of the second type multimedia content display interface, the method further comprises: displaying at least one second type multimedia content which is locally pre-cached, on the second content display layer of the second type multimedia content display interface.

9. The method according to claim 8, wherein after the displaying the at least one second type multimedia content which is locally pre-cached, on the second content display layer of the second type multimedia content display interface, the method further comprises:
receiving a second sliding operation inputted by the user on the second user interaction layer of the second type multimedia content display interface; and
displaying the first type multimedia content on the second content display layer of the second type multimedia content display interface.

10. The method according to claim 1, further comprising:
receiving a click operation inputted by the user on the first user interaction layer, and entering an information interface related to the first type multimedia content.

11. (canceled)

12. An electronic device, comprising a processor configured to execute a computer program stored in a memory, wherein the computer program, when executed by the processor, causes the processor to:
display first type multimedia content on a first content display layer of a first type multimedia content display interface, wherein the first type multimedia content display interface comprises a first user interaction layer and the first content display layer, and the first user interaction layer is superimposed and displayed on the first content display layer; and
receive a first sliding operation inputted by a user on the first user interaction layer, and exit the first type multimedia content display interface.

13. A non-transitory computer-readable storage medium, storing a computer program, wherein the computer program, when executed by a processor, causes the processor to:
display first type multimedia content on a first content display layer of a first type multimedia content display interface, wherein the first type multimedia content display interface comprises a first user interaction layer and the first content display layer, and the first user interaction layer is superimposed and displayed on the first content display layer, and
receive a first sliding operation inputted by a user on the first user interaction layer, and exit the first multimedia content display interface.

14. (canceled)

15. The electronic device according to claim 12, wherein the computer program, when executed by the processor, causes the processor to:
display exit prompt information on the first user interaction layer, before the first sliding operation inputted by the user on the first user interaction layer is received, wherein the exit prompt information is used to prompt to exit the first type multimedia content display interface through the first sliding operation.

16. The electronic device according to claim 15, wherein the exit prompt information comprises text prompt information and/or graphic prompt information, and wherein the graphic prompt information comprises a sliding direction icon used to indicate a sliding direction of the first sliding operation.

17. The electronic device according to claim 15, wherein the exit prompt information is displayed on the first user interaction layer with a dynamic effect.

18. The electronic device according to claim 15, wherein the exit prompt information is displayed on the first user interaction layer at a time delayed from a start display time of the first type multimedia content by a preset time.

19. The electronic device according to claim 12, wherein the first type multimedia content comprises open screen information.

20. The electronic device according to claim 12, wherein the computer program, when executed by the processor, causes the processor to:
send a request to a server, wherein the request is used for requesting second type multimedia content from the server; and
display the second type multimedia content acquired from the server on a second content display layer of a second type multimedia content display interface, after the first type multimedia content display interface is exited, wherein the second type multimedia content display interface comprises a second user interaction layer and the second content display layer, and the second user interaction layer is superimposed and displayed on the second content display layer.

21. The electronic device according to claim 20, wherein after the first type multimedia content display interface is exited, and before the second type multimedia content acquired from the server is displayed on the second content display layer of the second type multimedia content display interface, the computer program, when executed by the processor, causes the processor to:
display at least one second type multimedia content which is locally pre-cached, on the second content display layer of the second type multimedia content display interface.

22. The electronic device according to claim 21, wherein after the at least one second type multimedia content which is locally pre-cached, is displayed on the second content display layer of the second type multimedia content display interface, the computer program, when executed by the processor, causes the processor to:
receive a second sliding operation inputted by the user on the second user interaction layer of the second type multimedia content display interface; and
display the first type multimedia content on the second content display layer of the second type multimedia content display interface.
